(19) United States
(12) Patent Application Publication
(10) Pub. No.: US 2016/0259033 A1
(43) Pub. Date: Sep. 8, 2016

(54) LOCATING A TAG IN AN AREA

(71) Applicant: BEESTAR BV, Amsterdam (NL)

(72) Inventors: Sergey Igorevich Vladimirov, Amsterdam (NL); Emanuele Francioni, Amsterdam (NL); Charlotte Maria Aldarwish - Van Kiel, Amsterdam (NL); Fulvio Venturelli, Amsterdam (NL)

(73) Assignee: BEESTAR BV, Amsterdam (NL)

(21) Appl. No.: 15/003,838

(22) Filed: Jan. 22, 2016

Related U.S. Application Data
(63) Continuation of application No. PCT/EP2013/065642, filed on Jul. 24, 2013.

(51) Int. Cl. G01S 5/04; G01S 3/50

(52) U.S. Cl. CPC G01S 5/04; G01S 3/50

(57) ABSTRACT

A method and system for locating a tag. The system has a first receiver configured to receive a signal from a tag. The first receiver has at least two antennas each configured to receive the signal. The system is configured to calculate a first angle of arrival of the signal at the first receiver based on a distance between a first set of two antennas of the first receiver and a time difference of arrival of the signal at the two antennas of the first set. The tag has a tag antenna that is configured to transmit signals having a wide bandwidth and has a frequency independent phase center and wherein the signal is an ultra wideband signal having one or more pulses.

### CROSS REFERENCE TO RELATED APPLICATIONS

This application is a continuation of PCT application number PCT/EP2013/065642 filed on 24 Jul. 2013, the disclosure of which is hereby incorporated by reference in its entirety.

### BACKGROUND OF THE INVENTION

1. Field of the Invention

The invention relates generally to positioning and/or tracking of tags in an area, and more particularly, to a system for locating a tag, a first receiver for use in a system for locating a tag and a method for locating a tag.

2. Description of the Related Art

Systems for positioning and tracking of nodes in an area are known. Solutions based on Near Field ID Cards and barcodes e.g. can provide snapshots of discrete moments, but fail in providing a complete, up to date and accurate knowledge of the whereabouts of nodes. Systems based on e.g. WIFI, Bluetooth and Zigbee provide positioning possibilities, but behave poorly in the neighborhood of walls, people and water sources. This is due to the fact that these technologies operate in a bandwidth that has been conceived for data transmission purposes and they are improperly employed in poorly designed short range tracking solution. Other known GPS or GPRS/3G solutions are expensive and provide best localization outdoors only.

WO 03/028278 discloses a system and method for determining an angular offset of an impulse radio transmitter using an impulse radio receiver coupled to two antennas. The antennas are separated by some known distance, and one antenna can be coupled to the radio with cable delay. Impulse signals from the antennas are measured to determine the time difference of arrival of one such signal received by one antenna compared to that of the other antenna. Time differential is measured by autocorrelation of the entire impulse radio scan period, by detecting the leading edges of both incoming signals or various combinations of these methods. Using a tracking receiver, the pulses may be continuously tracked thus providing real time position information.

In WO 03/028278 it is unclear how to solve the problems inherent to the employment of ultra-wideband (UWB) for angular offset determination. This, in facts, strongly depends on keeping the distance between the antenna's phase centers constant. Without constant phase centers, the UWB signal characteristic of spanning across a large number of frequencies, would introduce intolerable phase distortion which would vary the aforementioned distance, making the determination of the angular offset less accurate or even not possible. Also, it is not disclosed how the high frequency characteristics of UWB signals can be used and processed. Furthermore it is not apparent how in WO 03/028278 the angular offset can be found for multiple impulse radio transmitters. It appears that only one impulse radio transmitter can be positioned in WO 03/028278. There is a need for an improved system for accurate locating and/or tracking of multiple and potentially fast moving objects both indoor and outdoor.

### BRIEF SUMMARY OF THE INVENTION

The present invention enables locating and/or tracking of (possibly multiple and fast moving) tags both indoor and outdoor. The tags may be worn by persons or animals, e.g. embedded in clothing, or integrated in an object such as a ball. The invention makes it possible to locate and/or track fast moving objects with high accuracy (e.g. within 20 cm precision).

In an aspect of the invention a system is proposed for locating a tag. The system can comprise a first receiver configured to receive a signal from a tag. The first receiver can comprise at least two antennas each configured to receive the signal. The system can further comprise a first processing means configured to calculate a first angle of arrival of the signal at the first receiver based on a distance between a first set of two antennas of the first receiver and a time difference of arrival of the signal at the two antennas of the first set. The tag can comprise a tag antenna that is configured to transmit signals having a wide bandwidth and that can have a frequency independent phase center. The signal can be an ultra wideband signal comprising one or more pulses.

In another aspect of the invention a method is proposed for locating a tag. The method can comprise receiving a signal from a tag in a first antenna of a first receiver. The method can further comprise receiving the signal from the tag in a second antenna of the first receiver. The method can further comprise calculating a first angle of arrival of the signal at the first receiver based on a distance between the first antenna and the second antenna and a time difference of arrival of the signal at the first antenna and the second antenna. The tag can comprise a tag antenna that is configured to transmit signals having a wide bandwidth and that can have a frequency independent phase center and wherein the signal is an ultra wideband signal comprising one or more pulses.

Thus, the tag antenna has a frequency independent phase center and can operate at a high bandwidth (UWB). This advantageously enables high speed and precise time measurements at the receiver of potentially multiple tags. By using an UWB signal in combination with a frequency independent phase center it becomes possible to have a high speed signal comprising pulses with sharp edges that can be processed by the receiver for time measurement purposes, i.e. measuring a time difference between the moment a pulse arrives at the first antenna and the moment the same pulse arrives at the second antenna. This time difference is used together with a known distance between the two antennas to calculate the angle between the receiver and the tag. The angle is part of location information of the tag.

The embodiments of claims 2 and 13 advantageously enable the position of the tag (i.e. not only the angle) to be determined using a single receiver having three or more antennas.

The embodiments of claims 3 and 14 advantageously enable the position of the tag (i.e. not only the angle) to be determined using two or more receivers each having two or more antennas.

The embodiments of claims 4 and 15 advantageously enable accurate time difference calculations on high resolution pulses.

The embodiments of claims 5 and 16 advantageously enable accurate time difference calculations on high frequency pulses with lower cost hardware. By stretching the high resolution signal through subsampling the time difference calculation can be performed at a lower resolution.

The embodiments of claims 6 and 17 advantageously enable an alternative accurate time difference calculations on high frequency pulses with lower cost hardware. By stretching the signal through subsampling the time difference calculation can be performed at a lower resolution. Furthermore, by performing the cross-correlation in the frequency domain high performance multipliers are not required.

The embodiments of claims 7 and 18 advantageously increase the accuracy of the time difference of arrival calculation.

The embodiments of claims 8 and 19 advantageously enable the tag to be small sized, e.g. coin sized. Furthermore, the tag can be very flat, enabling it to be e.g. comfortably integrated in clothing. The leaky lens antenna has a frequency independent phase center and is particularly suitable for generating UWB signals. It has been found by surprise that the properties of the leaky lens antenna can be used for accurately locating a tag utilizing the leaky lens antenna for transmitting UWB pulses. These UWB pulses have sharp edges. It has advantageously been found that these characteristics can be used as defined in the claims. As a result the signal at the receiving antennas has a high quality compared to prior art signals used for localizing tags. Because of the high frequencies used in UWB, the receiver of the present invention is typically adapted for fast processing of the signal.

The embodiments of claims 9 and 20 advantageously enable tags to be localized in multiple planes (i.e. dimensions).

The embodiments of claims 10 and 21 advantageously enable specific use cases, such as following players in a sports event or following the movements of an object such as a ball.

According to another aspect of the invention a first receiver is proposed having one or more of the above described characteristics.

Hereinafter, embodiments of the invention will be described in further detail. It should be appreciated, however, that these embodiments may not be construed as limiting the scope of protection for the present invention.

### BRIEF DESCRIPTION OF THE SEVERAL VIEWS OF THE DRAWINGS

The features and advantages of the invention will be appreciated upon reference to the following drawings, in which:

FIG. 1 shows an angle of arrival detection set up of an exemplary embodiment of the invention;

FIG. 2 shows a graph related to the viewing angle of an exemplary embodiment of the invention;

FIGS. 3 and 4 show location detection set ups of exemplary embodiments of the invention;

FIG. 5 shows a pulse of a signal of an exemplary embodiment of the invention;

FIG. 6 shows a receiver of an exemplary embodiment of the invention in more detail;

FIG. 7 shows a tag of an exemplary embodiment of the invention in more detail;

FIG. 8 shows a signal of an exemplary embodiment of the invention;

FIG. 9 shows two signal of an exemplary embodiment of the invention;

FIG. 10 shows a tag and a receiver of an exemplary embodiment of the invention;

FIG. 11 shows a tag and two receivers of an exemplary embodiment of the invention;

FIGS. 12 and 13 show a receiver of exemplary embodiments of the invention in more detail; and

FIG. 14 shows a soccer stadium for a use case of an exemplary embodiment of the invention.

### DESCRIPTION OF ILLUSTRATIVE EMBODIMENTS

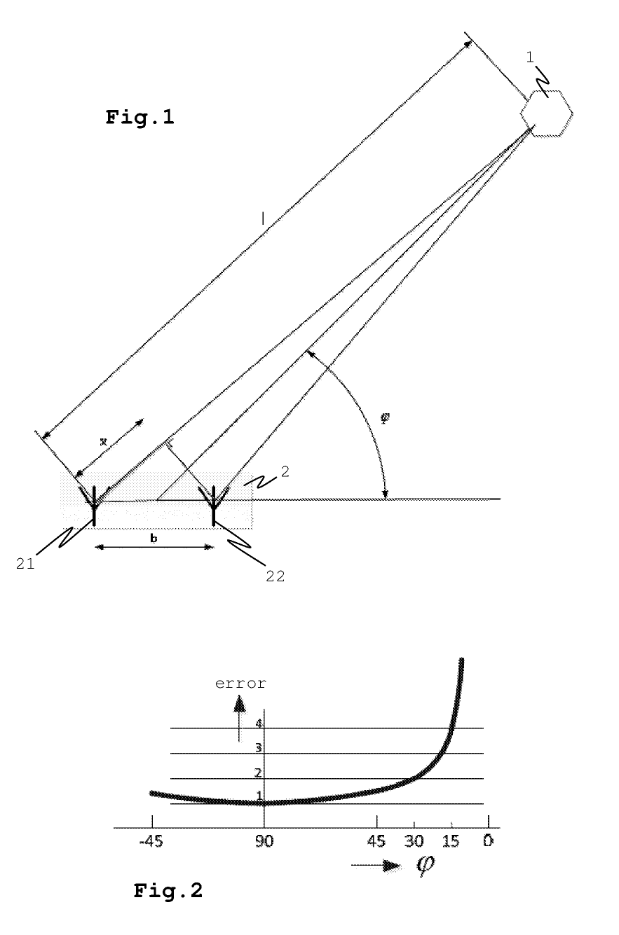

The following is a description of certain embodiments of the invention, given by way of example only and with reference to the drawings. FIG. 1 shows a basic set up for an estimation of an angle of arrival of a signal originating from a tag 1 at two antennas 21,22 of a receiver 2. The tag 1 transmits an electromagnetic wave or pulse. The signal path 1 from the tag to the left antenna 21 is longer than the path to the right antenna 22, as shown in FIG. 1. This path difference may be measured as a time difference of arrival of the signal at the left antenna 21 and the right antenna 22. The time difference may be converted to a distance difference x as shown in FIG. 1. Under the condition that the distance from the tag 1 to the receiver 2 is bigger than the distance b between the two receive antennas 21,22, the following relation between the angle φ and the distance x holds:

φ=arcos(x/b) [equation 1]

Inaccuracies in x will result in an error in the angle φ. The following relation may be derived regarding the error in x and φ:

Δφ=−Δx/√(b²−x²)=−Δx/b sin(φ) [equation 2]

In equation 2 Δx is the error in the distance [m], Δφ is the error in the angle [rad], x is the measured distance difference [m] with −b<x<b, and b is the distance between the left 21 and right 22 antenna centre.

FIG. 2 shows a graph of the error as function of the angle. The graph is the result of trial measurements. The angle measurement is most accurate for a viewing angle of approximately 120 degrees (between −30 degrees and 30 degrees as show in FIG. 2). At 30 degrees the error is 2 times the error at 90 degrees.

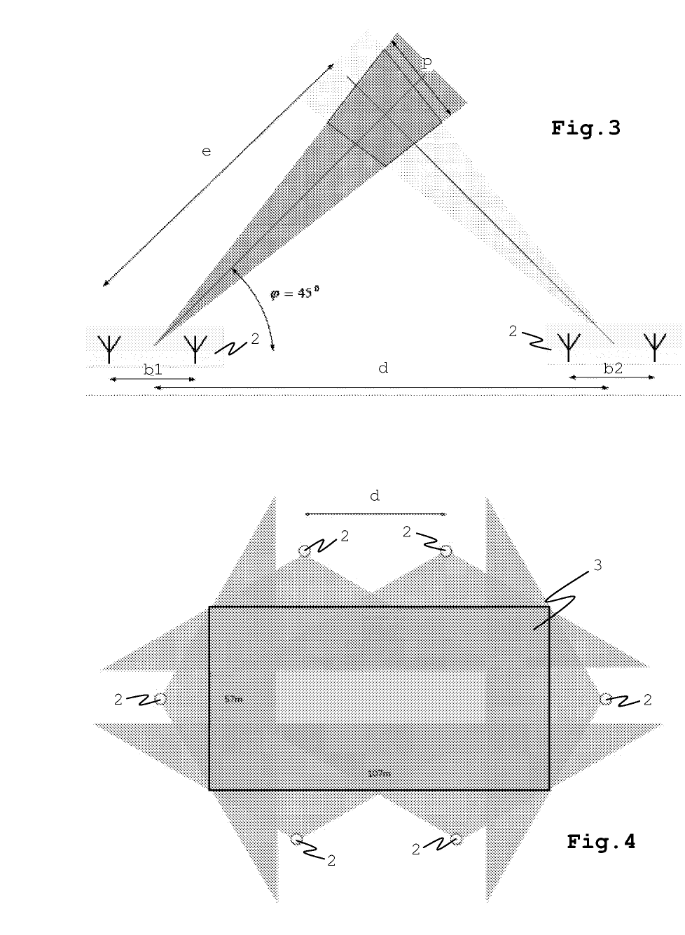

Position measurement in a plane is possible with two receivers that each measure the angle φ as shown in FIG. 1. In FIG. 3 the distance between the two receiving antennas are b1 for the first receiver and b2 for the second receiver. The two receivers are positioned at a distance d from one another (measured from the center of the receiving antennas). The interception between the two lines defined by the angles gives the location of the tag. In the example of FIG. 3 the estimated area of the tag is given at a 45 degrees angle φ for both receivers given a certain angle error. The angle error is indicated as the grey triangular area around the angle φ. The cross section of the two triangular areas defines the target area wherein the tag is located. In FIG. 3 the side of the rectangle of the target area is called p. When the error Δφ of the calculated angle is small we may approximate the distance p by:

P=eΔφ [equation 3]

Herein e is the distance from the receiver to the tag.

Position measurement in multiple planes, e.g. a horizontal and a vertical plane or planes in any other mutual orientation, is possible with different sets of antennas having corresponding aperture settings for the particular plane.

From the derived equations 1, 2 and 3 a specification for the required accuracy of the receiver(s) may be derived. In the example of FIG. 4 the location of the tag is to be detected in a rectangular area 3 of 57 m by 107 m. In this example the receivers 2 are placed at least 20 m outside the detection rectangle 3. The viewing angle of each receiver is assumed to be 120 degrees and is indicated by the triangles originating from the receivers 2. The detection range may be about 80 meters. With the use of 6 receivers 2, as shown in FIG. 4, there will be four useful detections of different receivers for every position. When for example the worst case detection accuracy area is defined as a square of 20 cm by 20 cm, specifications for the angle measurement accuracy may be derived as follows.

Using equation 3 the requirement for the angle error may be derived. Thus, in the example of FIG. 4 the angle is derived to be 2.5·10⁻³ rad (0.14 degrees). When using equation 2 a specification for the distance difference accuracy as measured by the two antennas 21,22 of the receiver 2 may be derived. With a distance b of 3 m between the two antennas 21,22 of the receiver 2, the distance accuracy may be derived to be:

Δx=Δφ*b=2.5·10⁻³*2.5=6 mm or better

The timing error may be calculated with:

Δt<Δx/c [equation 4]

From equation 4 and the calculated Δx it follows that in this example the accuracy of the time measurement should be better than 20 ps. The system specifications in the example of FIG. 4 may thus be as follows: Measure distance=80 m; Position accuracy=0.2 m; Distance difference accuracy <6 mm; Time accuracy <20 ps; Distance between two antennas of a receiver=3 m.

An accurate difference time of arrival measure system may start with a very short well defined transmit pulse from the tag antenna of the tag 1. The invention makes use of ultra-wideband (UWB) technique of very short pulses for communication and localization. State of the art ultra-wideband technology typically uses pulses with a duration of about 300 ps and a bandwidth from 3.1 GHz to 10.6 GHz. For Europe a bandwidth between 6 GHz and 8.5 GHz may be used. For the detection of an undistorted sharp pulse, the transmission path is preferably free of obstacles. Preferably the receiving system 2 has a very linear wide bandwidth. The tag antennas preferably have a wide bandwidth and a frequency independent phase center.

An example of a suitable antenna is a so called leaky lens antenna. A leaky lens antenna can be small (e.g. 4 cm×6 cm, 30 mm×80 mm or coin-sized, depending on the use case) and thin (e.g. such that it can be integrated in a t-shirt).

The average power of a pulse sequence in the 6 GHz to 8.5 GHz band is preferably lower than −41.3 dBm/MHz. The average power depends on the number of pulses per second (duty cycle). With for instance a pulse width of 600 ps and a pulse repetition rate of 100 ns the average power is 0.006 times the peak power. According to standardized UWB requirements an average power of 2.5 GHz/1 Mhz (dB) plus −41.3 dBm=−7 dBm is allowed. Based on the duty cycle of 0.006 the peak power is typically lower than 15 dBm. A 15 dBm peak power for a 2.5 GHz 600 ps pulse is lower than 0 dBm/50 MHz as required by the standard. A practical pulse with a peak value of about 1V produces a peak power in 50 Ohm of about 10 dBm.

Given the pulse width and the pulse power it is possible to give an estimate of the detection range. One of the fundamental boundaries is formed by the thermal noise. The thermal noise power may be calculated with the following equation:

Pₙₒᵢₛₑ=kTB [equation 5]

Herein, k is the constant from Boltzmann (1.38·10⁻²³ J·K⁻¹), T is the resistors absolute temperature (e.g. 300K) and B the bandwidth (6000 MHz to 8500 MHz=2.5 GHz). In this example the noise floor will thus be 10 pW. This is a noise floor of −80 dBm. With a pulse power of 10 dBm from the example above, the signal to noise ratio may be calculated as function of the distance e.

The received power density from the tag 1 as function of the distance e is given by the following equation:

E_{receive}=PₜGₜ/4πr² [equation 6]

Herein, Pₜ is the transmitted power at the tag, Gₜ is the gain of the tag antenna and r is the distance from the transmitter (i.e. tag antenna) to the receiver (i.e. the antenna 21,22 of the receiver). The power density at the receiver multiplied with the effective receiver antenna area gives the input power from the receiver:

$$\begin{matrix}{P}_{receive} = {E}_{receive} ( {λ}^{2} / 4 π ) {G}_{r} \\ = {P}_{t} {G}_{t} {G}_{r} {λ}^{2} / {( 4 π r )}^{2}\end{matrix} \qquad [ equation 7 ]$$

Herein, λ is the wave length of the radio signal (e.g. for 7 GHz the wave length is 43 mm) and Pt is a transmitter power (e.g. 10 mW).

If for example the transmit antenna gain equals 6 dB (i.e. 4×), this is a tag antenna gain that can be realized with a leaky lens structure of 6 cm×3 cm worn on the shoulder of a person, and a receive antenna gain of 12 dB (i.e. 16×), there will be a path loss of 51 dB at 10 meter and 69 dB at 80 meter. This example shows that at 80 meters distance, as in the example of FIG. 4, the signal power will be −41 dBm and the noise level will be −80 dBm. Based on these specifications there will be a 39 dB signal to noise ratio (SNR) at a distance of 80 meter. The noise figure and the losses from the radio frequency (rf) hardware may result in a degradation of the signal to noise ration, typically from about 10 dB. With that taken into account the signal to noise ratio at 80 meters may be 29 dB.

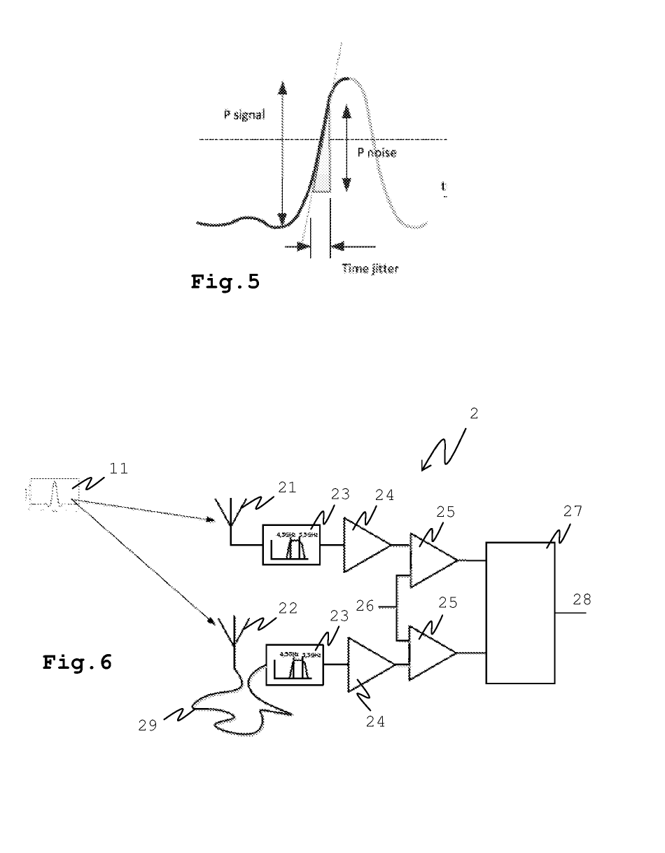

Given a certain signal to noise ratio an estimate can be given of the time accuracy that can be measured. With reference to FIG. 5, with a pulse rise time tᵣ, a signal power P_{signal} and a noise power Pₙₒᵢₛₑ, the time jitter Δt may be calculated with the following equation:

Δt=tᵣ√(Pₙₒᵢₛₑ/P_{signal})=tᵣ/√(SNR) [equation 8]

With a signal to noise ratio of e.g. 29 dB and a pulse rise time of e.g. 300 ps the time jitter is thus calculated to be about 0.5 ps. With equation 4 is was derived for the given example that the timing accuracy should be better than 20 ps. The influence of thermal noise on the accuracy of the measured time at distance of 80 meters is typically small. The influence from environmental noise (other rf sources, jammers) is difficult to estimate but could have an impact on the performance. When the noise level is dominated by those sources it is possible to increase accuracy by averaging a sequence of pulses.

FIG. 6 shows a receiver 2 of an exemplary embodiment of the invention. The receiver receives a signal 11 from a tag at two antennas 21,22. The received signal is processed by a band filter 23 and a low nose amplifier 24. The processed signals from the two antennas 21,22 go thru a comparator 25 having a threshold voltage 26. The output from the comparator 25 is input to the timer 27, which may use the output from the top comparator 25 as a start trigger and the output from the bottom comparator 25 as a stop trigger. The output of the timer 27 is an indication of a time difference 28 of arrival of the signal 11 at the two antennas 21,22. To ensure that the stop trigger is later in time than the start trigger a cable 29 between the second antenna 22 and the band filter 23 may be installed to introduce a signal delay of e.g. 4 ns. This delay can later be deducted from the time difference 28 to get the real time difference.

The receiver 2 of FIG. 6 typically has a dynamic range which is based on the minimum and maximum distance from the tag 1. With a minimum distance of e.g. 10 meters and a maximum distance of e.g. 80 meters a dynamic range of 18 dB (line of sight) should be sufficient. An extra margin of 12 dB because of path losses, obstacles and antenna zeros may be needed.

Better results may be obtained when the threshold level is made adaptive. A practical setting is a threshold which is about 10 dB above the rms noise level.

The timer 27 is typically a time to digital converter (TDC). In the examples above the TDC needs a time resolution of 10 ps and a maximum timing range of at least 4 ns. E.g. Acam™ produces time to digital ICs with a timing resolution of 10 ps. This IC may thus be suitable for use in the receiver 2.

The TDC may be used with high frequency tag signals (such as signals in the GHz range) that do not to be synchronized when using multiple antennas 21,22. Because the start and stop of the timer is to be triggered, the pulses in the signal have sharp edges. The sharp edges are obtained by using UWB high frequencies.

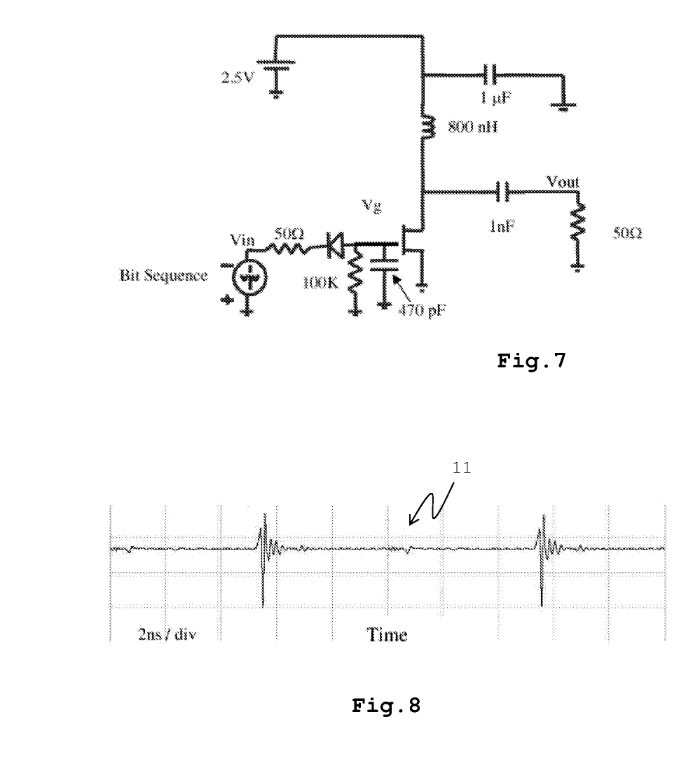

The tag 1 may contain a digital processor which produces a certain data sequence. An RF circuit may convert this sequence to a sequence of UWB pulses with a frequency bandwidth of e.g. 2.5 GHz (i.e. 6 GHz to 8.5 GHz). The UWB converter of the tag may be built with a simple FET and a few components, such as shown in FIG. 7. The coil (e.g. 800 nH) which is connected to the drain of the FET will differentiate the incoming digital pulses of the bit sequence. A packaged Schottky diode with wire leads, a resistance of 100K and capacitor of 470 pF are used in the input side of the FET. The action of the diode is as follows: for the falling edge, the gate of the FET is rapidly pulled through the ON diode to the negative input voltage (−2.5 V). This causes an abrupt turn-off of the FET, thus abruptly diverting the drain current into the L-C at the output, which generates the UWB pulse. For the rising edge, the gate and the 470 pF capacitor have to discharge through the resistor, the diode being OFF. This slows the turn-on of the FET, and the drain current rises gradually. This gradual turn-on leads to a negligibly weak output pulse generated by the L-C network at the rising edge of the input. Examples of ultra high speed comparators that may be used are ADCMP566 from Analog Devices™ and MAX9601 from Maxim™. E.g. the ADCMP566 in combination with a passive network and an antenna may be used as UWB transmitter.

FIG. 8 shows an example of an output pulse from the digital to UWB converter of FIG. 7. This output pulse may be transmitted from the tag 1 as the signal 11 to be received by the receiver(s) 2.

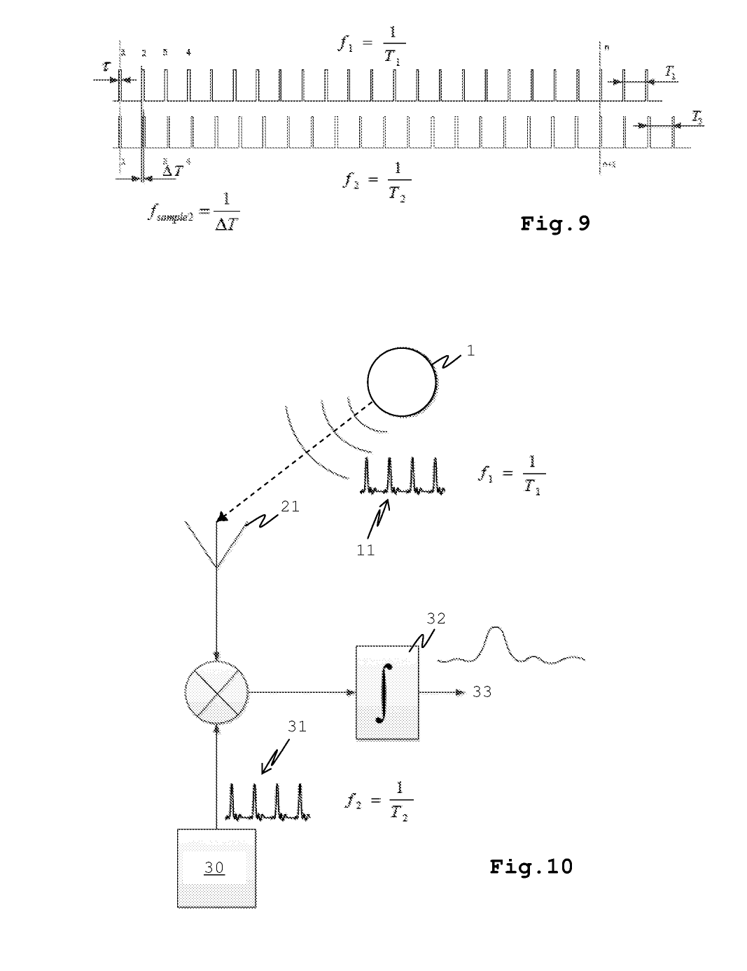

A low cost technique for time to digital conversion may be achieved by subsampling. With subsampling two different frequencies are used for the pulse repetition frequency of the tag 1 and the receiver 2. FIG. 9 and FIG. 10 show an example of the concept of subsampling. In FIG. 9 a tag pulse repetition sequence (top sequence) and receiver generated repetition sequence (bottom sequence) are shown. In FIG. 10 a tag 1 transmitting a signal 11 to an antenna 21 of a receiver 2 is shown. The receiver multiplies the incoming pulses from the tag with a further signal 31 generated by a pulse generator 30 in the receiver 2.

As indicated in FIG. 9, two pulse repletion frequencies f₁ and f₂ with a frequency difference Δf and a period difference ΔT may be used. The mixer integrator function 32 shown in FIG. 10 can be regarded as a correlation function from the transmitter pulse 11 and the pulse 31 from the pulse generator 30 for one fixed correlation time. The periodic shift from ΔT during a pulse sequence period produces a new sample from the correlation function. The output 33 from the integrator 32 produces the correlation function from the ultra wide band pulse stretched over a much longer time. For the sample step (which may be considered as time resolution) of the correlation function we may derive:

ΔT=Δf/f₁²

With for example a pulse repetition frequency of 20 MHz (50 ns) and a frequency difference of 4 kHz, the time resolution equals 10 ps. In this example with the 50 ns pulse repetition time and 10 ps shift per pulse sequence period, a stretch factor of 50 n/10 p=5000 is obtained. The relative short UWB pulses (for instance 200 ps) appear at the output 33 from the integrator 32 as a pulse 5000 times longer (as a pulse of for instance 1 μs). For angle measurement this principle is applied to two channels, i.e. using two antennas 21,22. The difference in time from the two down sampled pulses is a measure for the angle.

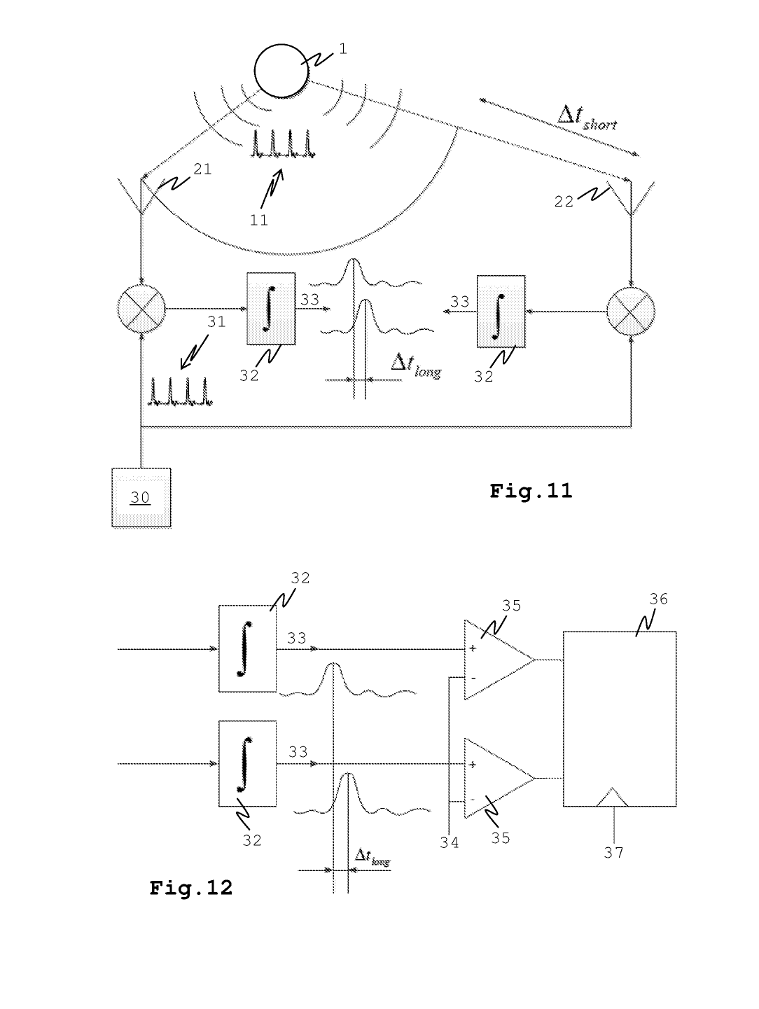

FIG. 11 gives an example of how this difference in time from the two down sampled pulsed may be obtained. The elements shown in FIG. 10 for one antenna 11 are shown in FIG. 11 for two antennas 21,22. When the two stretched pulses at the output of the integrators 32 have a time difference Δt_{long}, the real world time difference of arrival may be calculated of the two UWB pulses at the antenna location Δtₛₕₒᵣₜ as follows:

Δtₛₕₒᵣₜ=Δt_{long}Δf/f₁

Herein, f₁ is the pulse repletion frequency from the UWB pulses. Δf is the difference in the repetition frequency from the pulses from the transmitter and the internal pulse generator from the receiver. The maximum difference of arrival from the two UWB pulses is determined by the distance between the two base station antennas. With for instance a distance between the antennas of b=2 meters the maximum time difference of arrival will be 6.7 ns. For the stretched pulses this maximum delay is multiplied by the stretch factor. With for example Δf=4 kHz and f₁ is 20 MHz the stretch factor is 5000, which gives a maximum delay of 5000×6.7 ns=33 μs. If a resolution of 10 ps (unstretched) is desired, a time interval of at least 50 ns is to be measured.

A basic detector and counter such as shown in FIG. 12 may be used for this purpose. The output 33 from the integrator 32 goes thru a comparator 23 having a threshold voltage 34. The output from the comparator 35 is input to the timer 36, which may use the output from the top comparator 35 as a start trigger and the output from the bottom comparator 35 as a stop trigger. In this example the may have a clock input 37 of 20 MHz/50 ns. The output of the timer 36 is an indication of a time difference of arrival of the signal 11 at the two antennas 21,22.

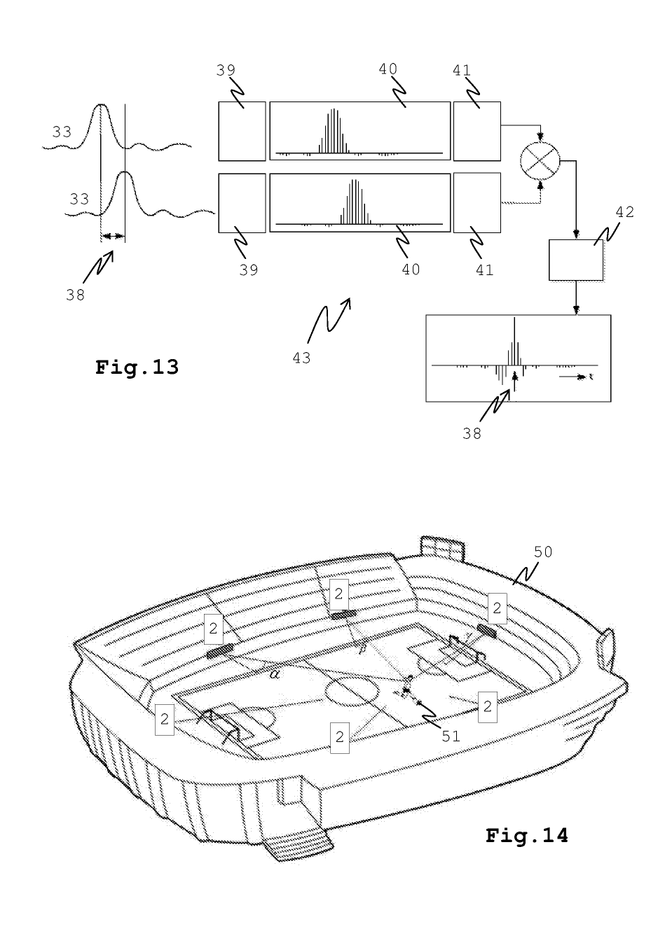

A more advanced detector may be used that calculates a cross correlation function between the two stretched pulses. A moving time domain cross correlation function would typically require an extreme number of multiplications per second. A cross correlation solution which will only need a fraction of the processing power performs the cross-correlation in the frequency domain and is given in FIG. 13. The cross-correlator 43 of FIG. 13 uses the stretched pulses 33 as input to an AD converter 39. The AD converted signal 40 is Fourier transformed by a Fast Fourier Transformer (FFT) 41. The resulting FFT transformed signals are multiplied and inverse Fourier transformed by Inverse Fast Fourier Transformer (IFFT) 42. The resulting signal from the IFFT 42 shows a peak at the time indicated by 38, which time equals the Δt_{long} of the stretched input pulses 33.

Thus, in order to perform the cross correlation in the frequency domain the incoming signal is sampled first (the preferred sample frequency is typically the update frequency of the UWB pulse sequence, e.g. of 20 MHz). The length of each window is typically twice the maximum time range (about 60 μs in this example). The following window will typically have 50% in common with the previous. With a 60 μs window time and 50 ns sample time it follows that the window has 1200 samples. The next step in the processing is performing the fast Fourier transform on the windows of both channels. Than multiply the two signals in the frequency domain and take the inverse Fourier transform. The result will be the cross correlation function of both pulses. The cross correlation function will have 1200 time samples. The location of the highest peak gives the time difference of the two incoming pulses. An ad converter with a resolution of 8 bit and 20 M samples/s would be sufficient. A processor which could perform a 1024-points FFT in 30 us time is feasible in modern FPGA's. In this example the duration of the pulse sequence of the transmitter (tag) should be at least ¼ kHz=250 us. One pulse sequence delivers one angle measurement. If e.g. four measurements per second are required, the transmitter will only transmit during 0.1% of the time. The collision chance in case of e.g. 20 transmitters in a detection area 3, which are all individually transmitting in random order, is very small.

Each transmitting sequence may consist of 5000 pulses for the localization of the tag 1. For transmitting data and and/or an identification (ID) code of the tag 1 additional pulses may be added. The ID code may be used to distinguish the different tags. The data and ID pulses may be modulated and typically do not deliver any signal for the subsample detector.

An ID code is not required to distinguish the tags, as the positioning of the tag is very accurate. By keeping track of the accurate position of the different tags the tags can be distinguished without using an ID code.

In the exemplary use case shown in FIG. 14, soccer players 51 are localized and tracked in a soccer stadium 50. The stadium is set up with six receivers 2, similar to the example of FIG. 4. The tag 1 (not shown) may be integrated in the shoulder part of the t-shirt of the player 51. In this example there is a required accuracy of 20 cm. The detection distance is set to 70 m. There are six receivers and 22 tags in the field (one for each player). It is possible to have more tags detected, e.g. an additional tag included in the ball or in other use cases any other number of tags. In the present use case with 22 detectable tags the angle resolution needs to be 0.2 degrees.

In FIG. 14, the receivers 22 may have antennas 21,22 that are placed 3 m apart. The viewing angle may be 120 degrees (horizontal angle) and the estimated area of the tag may be at a 45 degrees angle (vertical angle). The tag is small-sized, e.g. coin-sized and thin and is integrated in the shoulder part of the t-shirt of the soccer player 51.

Measurements at the receivers 2 on the signals from the tags on the soccer players are performed in approximately 20 ps time resolution, as also illustrated in the examples above. An Acam™ time to digital converter is used for single pulse measurement. The pulse from the tag is preferably at least 10 dB above noise level. Accuracy in the measurements is achieved by averaging a sum of measurements. Subsampling is used to stretch the signal using relatively low cost rf hardware. Herewith detection is possible with pulses lower than the noise floor. The detection circuit can be implemented with standard components. The subsampled signals are further processed using a cross-correlation function for time difference of arrival, such as illustrated in FIG. 13. A dual channel AD converter 10 bit/20MSPS FPGA (Altera cyclone 4 processor) may be used.

The pulse repetition frequency of the tag on the soccer player may be 17,000 MHz. The pulse repetition frequency of the signal from the pulse generator may be 17,006 MHz. This results in a frequency difference of 6 KHz (167 μs). A minimum required number of pulses for one stretched pulse in the present use case is typically around 2825. The time resolution is 21 ps. The UWB pulse with may be 500 ps. The FFT size (at a sample frequency of 17 MHz) is 256 (15 μs).

The tag on the soccer player operates at an update frequency of 5 Hz. Sensor data may be transmitted at 48 Kb (200 updates/s) or 1.2 Kb (5 updates/s). To transfer 1.2 Kb of data 2400 pulses may be used. For the angle measurement 2825 pulses may be used. The total number of pulses in the present use case is thus 5225. With 22 active tags the channel load is (only) 3%. The signal collision chance is low.

The UWB standard defines a −41.3 dBm/MHz average power. At a bandwidth of 2.5 GHz (34 dB) this gives an −7.3 dBm average power. The pulse duration is 500 ps and the pulse repetition 59 ns. This gives a peak to average ratio of 0.08 (−20 dB). The allowed peak power is then −7.3 dBm+20 dB=12.7 dBm. The noise floor (bandwidth 2.5 GHz)=−80 dBm. The signal power at 70 meters distance (with an antenna gain of the tag of 6 dB, an antenna gain of the receiver of 12 dB and noise figure and losses account for 6 dB)=−63 dBm. The UWB pulses of the tags on the soccer players are 17 dB above the noise at a distance of 70 m.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory or flash memory) on which alterable information is stored. Moreover, the invention is not limited to the embodiments described above, which may be varied within the scope of the accompanying claims.

Further modifications in addition to those described above may be made to the structures and techniques described herein without departing from the spirit and scope of the invention. Accordingly, although specific embodiments have been described, these are examples only and are not limiting upon the scope of the invention.

1. A system for locating a tag, the system comprising a first receiver configured to receive a signal from a tag, wherein the first receiver comprises at least two antennas each configured to receive the signal,
wherein the system is configured to calculate a first angle of arrival of the signal at the first receiver based on a distance between a first set of two antennas of the first receiver and a time difference of arrival of the signal at the two antennas of the first set, wherein the tag comprises a tag antenna that is configured to transmit signals having a wide bandwidth and has a frequency independent phase center and wherein the signal is an ultra wideband signal comprising one or more pulses.

2. The system according to claim 1, wherein the system is further configured to calculate a second angle of arrival of the signal at the first receiver based on a distance between a second set of two antennas of the first receiver and a time difference of arrival of the signal at the two antennas of the second set, wherein the system is further configured to calculate a position of the tag based on the first angle of arrival and the second angle of arrival.

3. The system according to claim 1, further comprising a second receiver configured to receive the signal from the tag, wherein the second receiver comprises at least two antennas each configured to receive the signal, wherein the system is configured to calculate a third angle of arrival of the signal at the second receiver based on a distance between a third set of two antennas of the second receiver and a time difference of arrival of the signal at the two antennas of the third set, wherein the system is further configured to calculate a position of the tag based on the first angle of arrival and the third angle of arrival.

4. The system according to claim 1, comprising a time to digital converter configured to output an indication of the time difference of arrival of the signal at the two antennas of a set, wherein an arrival of a pulse at a first of the two antennas of the set triggers a start of a timer of the time to digital converter and wherein the arrival of the pulse at a second of the two antennas of the set triggers a stop of the timer.

5. The system according to claim 1, wherein at least one receiver further comprises a pulse generator for generating a further signal, wherein the at least one receiver comprises a time to digital converter configured to output an indication of the time difference of arrival of the signal at the two antennas of a set, wherein a first peak in a first subsampled signal triggers a start of a timer of the time to digital converter, the first subsampled signal obtained from the signal at a first of the two antennas in the set and the further signal, and wherein a second peak in a second subsampled signal triggers a stop of the timer, the second subsampled signal obtained from the signal at a second of the two antennas in the set and the further signal.

6. The system according to claim 1, wherein at least one receiver further comprises a pulse generator for generating a further signal, wherein the at least one receiver comprises a cross-correlator configured to output an indication of the time difference of arrival of the signal at the two antennas of a set, wherein the at least one receiver is configured to generate a first subsampled signal from the signal at a first of the two antennas in the set and the further signal and to generate a second subsampled signal from the signal at a second of the two antennas in the set and the further signal, and wherein the cross-correlator is configured to digitize and Fourier transform the first subsampled signal and the second subsampled signal, to multiply the digitized and Fourier transformed first subsampled signal and the digitized and Fourier transformed second subsampled signal to obtain a multiplied signal, and to inverse Fourier transform the multiplied signal to obtain the indication of the time difference of arrival.

7. The system according to claim 1, wherein the system is configured to calculate the angle of arrival based on an average time difference of arrival of two or more pulses of the signal.

8. The system according to claim 1, wherein the tag antenna is a leaky lens antenna.

9. The system according to claim 1, wherein two sets of two antennas of a receiver are used for calculating an angle of arrival in a first plane and an angle of arrival in a second plane different from the first plane, respectively.

10. The system according to claim 1, wherein the tag is one of: a wearable tag for locating and/or tracking a person; and a tag in or on an object such as a sports object (e.g. a ball), for locating and/or tracking the object.

11. A first receiver for use in a system for locating a tag according to claim 1.

12. A method for locating a tag, the method comprising:
receiving a signal from a tag in a first antenna of a first receiver;
receiving the signal from the tag in a second antenna of the first receiver; and
calculating a first angle of arrival of the signal at the first receiver based on a distance between the first antenna and the second antenna and a time difference of arrival of the signal at the first antenna and the second antenna,
wherein the tag comprises a tag antenna that is configured to transmit signals having a wide bandwidth and has a frequency independent phase center and wherein the signal is an ultra wideband signal comprising one or more pulses.

13. The method according to claim 12, further comprising:
receiving the signal from the tag in a third antenna of the first receiver;
calculating a second angle of arrival of the signal at the first receiver based on a distance between the first antenna and the third antenna and a time difference of arrival of the signal at the first antenna and the third antenna; and
calculating a position of the tag based on the first angle of arrival and the second angle of arrival.

14. The method according to claim 12, further comprising:
receiving the signal from the tag in a fourth antenna of a second receiver;
receiving the signal from the tag in a fifth antenna of the second receiver;
calculating a third angle of arrival of the signal at the second receiver based on a distance between the fourth antenna and the fifth antenna and a time difference of arrival of the signal at the fourth antenna and the fifth antenna; and
calculating a position of the tag based on the first angle of arrival and the third angle of arrival.

15. The method according to claim 12, further comprising:
triggering a start of a timer of a time to digital converter by an arrival of a pulse at a first antenna of a set of two antennas;
triggering a stop of the timer by the arrival of the pulse at a second antenna of the set of two antennas; and
outputting an indication of the time difference of arrival of the pulse at the first antenna of the set and the second antenna of the set.

16. The method according to claim 12, further comprising:
generating a further signal by a pulse generator;
generating a first subsampled signal from the signal at a first antenna of a set of two antennas and the further signal;
generating a second subsampled signal from the signal at a second antenna of the set of two antennas and the further signal;
triggering with a first peak in the first subsampled signal a start of a timer of a time to digital converter;
triggering with a second peak in the second subsampled signal a stop of the timer; and
outputting an indication of the time difference of arrival of the signal at the first antenna of the set of two antennas and the second antenna of the set of two antennas based on the start and stop of the timer.

17. The method according to claim 12, further comprising:
generating a further signal by a pulse generator;
generating a first subsampled signal from the signal at a first antenna of a set of two antennas and the further signal;
generating a second subsampled signal from the signal at a second antenna of the set of two antennas and the further signal;
digitizing and Fourier transforming the first subsampled signal and the second subsampled signal by a cross-correlator;
multiplying the digitized and Fourier transformed first subsampled signal and the digitized and Fourier transformed second subsampled signal by the cross-correlator to obtain a multiplied signal; and
inverse Fourier transform the multiplied signal by the cross-correlator to obtain an indication of the time difference of arrival.

18. The method according to claim 12, further comprising calculating the angle of arrival based on an average time difference of arrival of two or more pulses of the signal.

19. The method according to claim 12, wherein the tag antenna is a leaky lens antenna.

20. The method according to claim 12, wherein two sets of two antennas of a receiver are used for calculating an angle of arrival in a first plane and an angle of arrival in a second plane different from the first plane, respectively.

21. The method according to claim 12, wherein the tag is one of: a wearable tag for locating and/or tracking a person; and a tag in or on an object such as a sports object (e.g. a ball), for locating and/or tracking the object.
